(19) United States
(12) Patent Application Publication
(10) Pub. No.: US 2006/0089158 A1
(43) Pub. Date: Apr. 27, 2006

(54) Method of determining a PHS mobile phone user's exact position

(75) Inventors: Cheng-Shing Lai, Taipei (TW); Wei Zhang, Nanking (CN)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei (TW)

(21) Appl. No.: 11/174,481

(22) Filed: Jul. 6, 2005

(30) Foreign Application Priority Data
Oct. 21, 2004 (TW) 093131930

(51) Int. Cl. H04Q 7/20

(52) U.S. Cl. 455/456.4; 455/457

(57) ABSTRACT

The prevent invention is to provide a method of determining a PHS mobile phone user's exact position, which comprises the steps of establishing a positioning database containing a plurality of CS (cell station) numbers and position information associated with the CS numbers respectively in the mobile phone; entering into a position inquiry mode of the positioning database chosen by the PHS mobile phone user; searching for a corresponding CS number in the positioning database based on a current CS number detected by the PHS mobile phone; and showing the position information associated with the current CS number on a display of the mobile phone when the corresponding CS number exists in the positioning database, so as to enable the user to determine a precise location by making a position inquiry through the mobile phone without having to pay any additional fee to PHS service provider.

### FIELD OF THE INVENTION

The present invention relates to a PHS mobile phone, more particularly to a method of determining a PHS mobile phone user's exact position by establishing cell station numbers and position information associated with the cell station numbers respectively in a positioning database with extensible functions in the mobile phone so as to enable the user to input new position information in the mobile phone by himself or herself without having to pay any additional fee to PHS service provider while enjoying PHS based position inquiry.

### BACKGROUND OF THE INVENTION

A wide variety of consumer electronics products, e.g., GSM (Global System for Mobile Communications) based cellular phones, and PHS (Personal Handy-phone System) mobile phones, etc., are commercially available in an even faster pace in recent years as electronics industry advances. Moreover, they are compact, lightweight, portable, and inexpensive. They are more convenient in use as compared with earlier wireless communication products and Internet access devices. Hence, they are closely associated with our daily life and work.

PHS has made a significant progress in recent years. Also, PHS mobile phones are widely promoted by many telephone companies. As a result, more and more people like to use PHS mobile phones. PHS is a low power communication system. PHS substantially has similar features as GSM. The differences therebetween, i.e., the characteristics of PHS are that the communication signal is transmitted from CS (cell station) to CS as a PHS mobile phone user moves around, the coverage of CS is small and the movement of PHS mobile phone is slow. Thus, PHS is particularly suitable to urban people.

It is a fact that more and more people use such powerful communication tools (i.e., PHS mobile phones) in their daily life. Unfortunately, its powerful features are not fully utilized yet. In comparison with powerful GSM based cellular phones, much less features are employed in PHS mobile phones.

As stated above, the coverage of CS is small. Thus, it is possible of determining a PHS mobile phone user's position more accurate via CSs than that did by a GSM based cellular phone.

PHS based positioning service has not been provided by PHS service providers. It is anticipated that PHS service providers may charge their users for each PHS based positioning service in the future if such positioning service is available. The inventor has been aware of the above trend and for the purpose of meeting market demand; the inventor spends a lot of time to establish a PHS database having a plurality of tables each associated with a corresponding CS number. As such, a location inquiry made by a PHS mobile phone user may result in an exact user position showing on the PHS mobile phone that the user holds. Moreover, the database can be expanded by enabling a user to input new data. Hopefully, the invention can increase competitiveness of one PHS manufacturer among similar products in the market.

### SUMMARY OF THE INVENTION

After considerable research and experimentation, a method of determining a PHS mobile phone user's exact position for free according to the present invention has been devised so as to remedy the foregoing and other deficiencies inherent in the prior art and contribute significantly to the advancement of the art. The deficiencies and proposed advancement of the present invention are as below.

PHS based positioning service has not been provided by PHS service providers. It is anticipated that PHS service providers may charge their users for each PHS based positioning service in the future if such positioning service is available. The present invention is thus able to provide a more convenient, practical service to PHS mobile phone users in their daily life by fully taking advantage of the feature of capable of providing a precise location inquiry by PHS mobile phone.

It is an object of the present invention to provide a method of determining a PHS mobile phone user's exact position. By utilizing this method, a couple of advantages are obtained as follows.

(i) a positioning database having a plurality of CS numbers and position information associated to the CS numbers respectively is established in a PHS mobile phone by the user. In use, a user can search for a corresponding CS number in the positioning database based on a current CS number detected by the PHS mobile phone at any time in which the position information associated with the corresponding CS number including location, traffic, nearby building, etc. has already been established by the user. Moreover, an authorized person is permitted to obtain a PHS mobile phone user's exact position by making a call to the user. As a result, whereabouts of the user can be known immediately.

(ii) The invention enables a user to establish a positioning database containing a plurality of frequently inquired CS numbers and the associated position information. The user does not need to pay any fee to PHS service providers when he/she enjoys benefits associated with the PHS based position inquiry.

The above and other objects, features and advantages of the present invention will become apparent from the following detailed description taken with the accompanying drawings.

### BRIEF DESCRIPTION OF THE DRAWINGS

FIG. 1 is a flow chart illustrating a process of inputting positioning data by a PHS mobile phone user according to the invention;

FIG. 2 is a flow chart illustrating a process of determining a PHS mobile phone user's exact position according to the invention; and

FIG. 3 is a flow chart illustrating a process of permitting an authorized person to obtain a PHS mobile phone user's exact position according to the invention.

### DETAILED DESCRIPTION OF THE PREFERRED EMBODIMENTS

The invention is directed to a method of determining a PHS mobile phone user's exact position comprising the steps of enabling the PHS mobile phone user to establish a positioning database containing a plurality of CS numbers and position information associated with the CS numbers respectively in the PHS mobile phone; receiving a position inquiry mode of the positioning database chosen by the PHS mobile phone user and entering into the position inquiry mode; searching for a corresponding CS number in the positioning database based on a current CS number detected by the PHS mobile phone; and showing the position information associated with the current CS number on a display of the PHS mobile phone when the corresponding CS number exists in the positioning database. By utilizing this method, a PHS mobile phone user does not need to pay any fee to PHS service providers when enjoying the PHS based position inquiry.

In the method of the invention following device and functions are provided and they are comprised of enabling the PHS mobile phone user to establish a positioning database containing a plurality of CS numbers and position information associated with the CS numbers respectively in the PHS mobile phone; receiving a position inquiry mode of the positioning database chosen by the PHS mobile phone user, enabling a PHS mobile phone user to inquire his/her exact position, and permitting an authorized person to obtain a PHS mobile phone user's exact position by making a call thereto.

In the method of the invention in response to enabling the PHS mobile phone user to establish the positioning database containing a plurality of CS numbers and position information associated with the CS numbers respectively and receiving a position inquiry mode of the positioning database chosen by the PHS mobile phone user, the PHS mobile phone performs the steps of entering into a positioning information mode of a function menu comprising a submenu including an exact position inquiry option and a supplementary database option; processing a position inquiry in the form of numeral (i.e., current CS number) detected by the PHS mobile phone; searching for a corresponding CS number in the positioning database based on the current CS number and reading the position information associated with the corresponding CS number, wherein the position information including location, traffic, and nearby building associated with the corresponding CS number; determining whether the position information associated with the corresponding CS number has already been established in the positioning database or not; and if the determination is positive showing the position information associated with the current CS number on the display of the PHS mobile phone. The method of the invention further permits the PHS mobile phone user to input and edit the position information to the positioning database when the supplementary database option is chosen by the PHS mobile phone user.

In the method of the invention in response to the exact position inquiry option chosen by the user for determining an exact position of the PHS mobile phone, the PHS mobile phone performs the steps of entering into a standby mode and receiving the position inquiry mode of the positioning database chosen by the user through pressing a shortcut key; and showing the position information on the display of the PHS mobile phone when the position information associated with the corresponding CS number has already been established in the positioning database.

In the method of the invention in response to a request of obtaining the PHS mobile phone user's exact position from a calling person, the PHS mobile phone performs the steps of receiving a short message about position inquiry of the PHS mobile phone user from the calling person, the message comprising a password; if the password is correct, searching for the exact position of the PHS mobile phone user immediately; and transmitting data of the exact position to the calling person. Alternatively, if the password is incorrect, the method of the invention disables the PHS mobile phone to get any related information and remaining the PHS mobile phone in its standby mode.

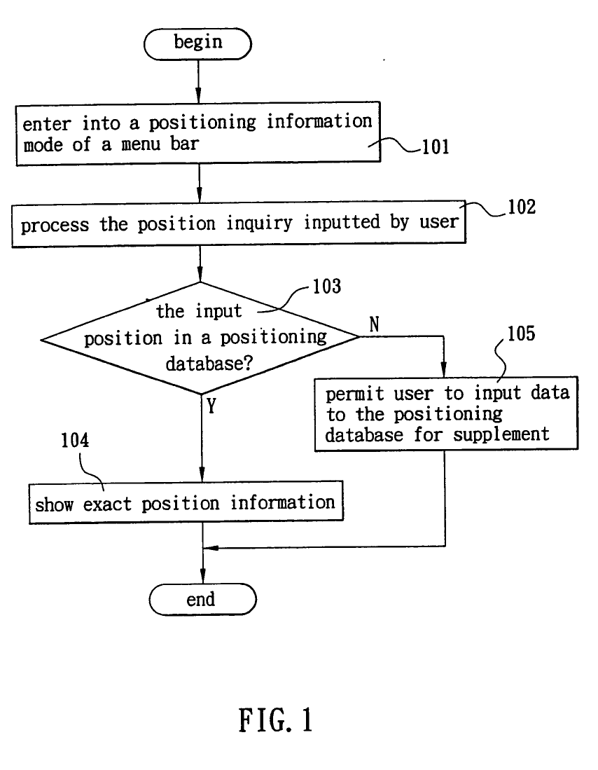

Referring to FIG. 1, there is illustrated a process of entering into a position inquiry mode of the positioning database chosen by the PHS mobile phone user according to the invention. The PHS mobile phone will perform the following steps in response to the position inquiry mode chosen by the PHS mobile phone user:

In step 101, entering into a positioning information mode of a function menu comprising a submenu including an exact position inquiry option and a supplementary database option.

In step 102, processing a current CS number detected by the PHS mobile phone according to the position inquiry mode chosen by the PHS mobile phone user and searching for a corresponding CS number (e.g., 123456789) in the positioning database based on the current CS number. The position information associated with the corresponding CS number includes location, traffic information and nearby landmark, etc. For example, the position information associated with the corresponding CS number 123456789 is Station St. (i.e., location), Bus No. 5 and No. 266 (i.e., traffic information), Central Park (i.e., nearby landmark) and the likes.

In step 103, determining whether the position information corresponding to the current CS number has been established in the positioning database or not. If yes, the process goes to step 104. Otherwise, the process jumps to step 105.

In step 104, showing the exact position information including Station St. (i.e., location), Bus no. 5 and no. 266 (i.e., traffic information), and Central Park (i.e., nearby landmark) on the display of the PHS mobile phone that the user holds when the user is located near Central Park. The process ends accordingly.

In step 105, permitting the PHS mobile phone user to input and edit a corresponding CS number and position information associated with the corresponding CS number to the positioning database when the supplementary database option is chosen by the PHS mobile phone user. For example, “nearby McDonald” is added to the positioning database as the position information about the nearby building. The process ends accordingly.

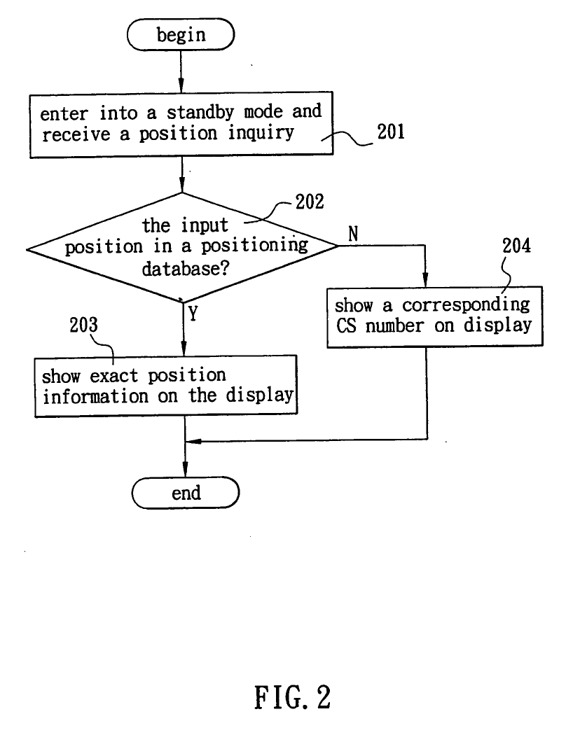

Referring to FIG. 2, there is illustrated a process of determining a PHS mobile phone user's exact position in response to the position inquiry mode chosen by the PHS mobile phone user according to the invention. The PHS mobile phone will perform the following steps thereafter:

In step 201, entering into a standby mode and receiving the position inquiry mode of the positioning database chosen by the PHS mobile phone user through pressing a shortcut key.

In step 202, determining whether the position information associated with the corresponding CS number has already been established in the positioning database or not. If yes, the process goes to step 203. Otherwise, the process jumps to step 204.

In step 203, showing the exact position information including Station St. (i.e., location), Bus no. 5 and no. 266 (i.e., traffic information), and Central Park (i.e., nearby landmark) on the display of the PHS mobile phone that the user holds. The process ends accordingly.

In step 204, showing the current CS number detected by the PHS mobile phone on the display thereof. The process ends accordingly.

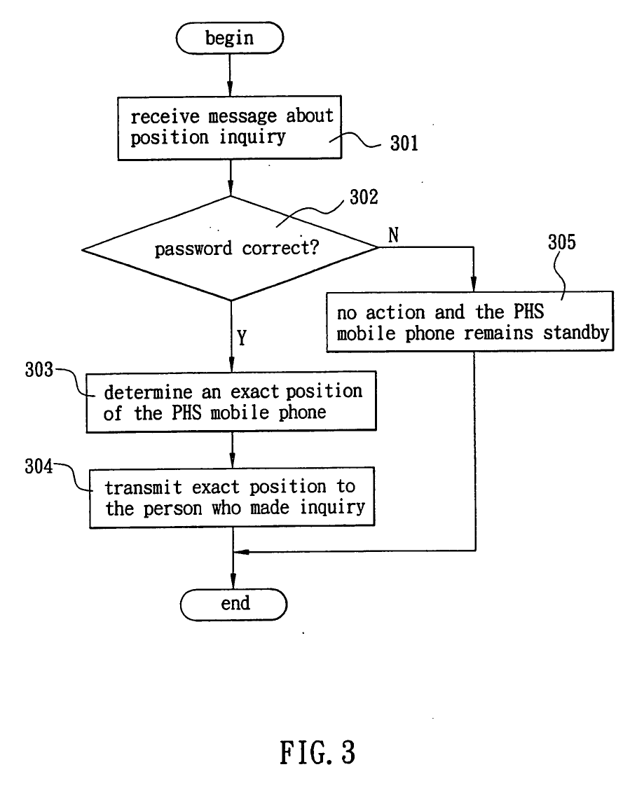

Referring to FIG. 3, there is illustrated a process of permitting an authorized person to obtain a PHS mobile phone user's exact position according to the invention. The PHS mobile phone will perform the following steps in response to a position inquiry of obtaining the PHS mobile phone user's exact position from a calling person:

In step 301, receiving a short message about the position inquiry of the PHS mobile phone user from the calling person, the message comprising a password.

In step 302, determining whether the password in the message is correct or not. If yes, the process goes to step 303. Otherwise, the process jumps to step 305.

In step 303, searching for an exact position of the PHS mobile phone immediately.

In step 304, transmitting the data of the exact position to the calling person who made the inquiry. The process ends accordingly.

In step 305, disabling the PHS mobile phone to get any related information in response and and maintaining the PHS mobile phone in its standby mode. The process ends accordingly.

It is clear from the above, parents may establish a positioning database in the PHS mobile phone prior to giving the PHS mobile phone to their children. As such, the parents may know the precise location of their children at any time by making a position inquiry. Alternatively, a family member may establish a positioning database in the PHS mobile phone prior to giving the PHS mobile phone to his/her elder family members having poor memory. As such, the person may know the precise location of the elder family member at any time by making a position inquiry. This method is useful of preventing the elder family members from missing. Of course, a PHS mobile phone user may determine a precise location of himself/herself by making a position inquiry through the PHS mobile phone. For example, an elder person may press a specific key on the PHS mobile phone for determining a precise location of himself/herself. Moreover, associated information about traffic information, nearby landmark, etc. (established by his/her family member previously) is shown on the PHS mobile phone in response to the inquiry. By utilizing the invention, a lot of advantages associated with position inquiry made by a PHS mobile phone are obtained.

While the invention herein disclosed has been described by means of specific embodiments, numerous modifications and variations could be made thereto by those skilled in the art without departing from the scope and spirit of the invention set forth in the claims.

What is claimed is:

1. A method of determining a PHS mobile phone user's exact position comprising the steps of:
establishing a positioning database containing a plurality of CS (cell station) numbers and position information associated with the CS numbers respectively in the PHS mobile phone;
entering into a position inquiry mode of the positioning database chosen by the PHS mobile phone user;
searching for a corresponding CS number in the positioning database based on a current CS number detected by the PHS mobile phone; and
showing the position information associated with the current CS number on a display of the PHS mobile phone when the corresponding CS number exists in the positioning database.

2. The method of claim 1, wherein in response to receiving the position inquiry mode of the positioning database chosen by the PHS mobile phone user the method further comprises the steps of:
entering into a positioning information mode of a function menu comprising a submenu including an exact position inquiry option and a supplementary database option;
searching for the corresponding CS number in the positioning database in response to the exact position inquiry option chosen by the PHS mobile phone user and reading the position information associated with the corresponding CS number; and
showing the position information associated with the corresponding CS number on the display of the PHS mobile phone, when the position information associated with the corresponding CS number has already been established in the positioning database.

3. The method of claim 2, wherein when the position information corresponding to the current CS number hasn't been established in the positioning database, the method further comprises the step of permitting the PHS mobile phone user to input and edit a corresponding CS number and position information associated with the corresponding CS number to the positioning database in response to the supplementary database option chosen by the PHS mobile phone user.

4. The method of claim 1, wherein in response to the position inquiry mode of the positioning database chosen by the PHS mobile phone user for determining an exact position, the method further comprises the steps of:
entering into a standby mode and receiving the position inquiry mode of the positioning database chosen by the PHS mobile phone user through pressing a shortcut key;
when the position information associated with the corresponding CS number has already been established in the positioning database, showing the position information on the display of the PHS mobile phone.

5. The method of claim 4, wherein when the position information corresponding to the current CS number hasn't been established in the positioning database, the method further comprises the step of showing the current CS number on the display of the PHS mobile phone.

6. The method of claim 1, wherein in response to a request of obtaining the PHS mobile phone user's exact position from a calling person, the method further comprises the steps of:
receiving a short message about position inquiry of the PHS mobile phone user from the calling person, the message comprising a password;
determining whether the password in the short message is correct or not;
when the password in the short message is correct, searching for an exact position of the PHS mobile phone immediately; and
transmitting the exact position to the calling person.

7. The method of claim 6, wherein when the password in the short message isn't correct, the method further comprises disabling the PHS mobile phone to get any related information and maintaining the PHS mobile phone in its standby mode.
